(19) United States
(12) Patent Application Publication
(10) Pub. No.: US 2026/0071788 A1
(43) Pub. Date: Mar. 12, 2026

(54) TEMPERATURE-CONTROL DEVICE FOR CONTROLLING THE TEMPERATURE OF A FLUID AND A METHOD FOR CONTROLLING THE TEMPERATURE OF A FLUID

(71) Applicant: Helmholtz-Zentrum Dresden - Rossendorf e.V., Dresden (DE)

(72) Inventors: Tino GOTTSCHALL, Dresden (DE); Thomas HERRMANNSDÖRFER, Dresden (DE)

(21) Appl. No.: 19/107,284

(22) PCT Filed: Sep. 5, 2023
(86) PCT No.: PCT/EP2023/074276

§ 371 Date: Feb. 27, 2025

(30) Foreign Application Priority Data
Sep. 8, 2022 (DE) 102022122835.5

(51) Int. Cl. F25B 21/00

(52) U.S. Cl. CPC F25B 21/00; F25B 2321/0022

(57) ABSTRACT

Disclosed herein is a temperature-control device for controlling the temperature a fluid and method thereof. The temperature-control device includes a coil with first and second coils aligned along a coaxial direction and spaced apart from each other so that a magnetic field can be generated within a region between them. The temperature-control device includes a magnetocaloric member attached movably relative to the coil such that the magnetocaloric member and the coil can be moved relative to each other along a direction at an angle to the coaxial direction in the region to generate a magnetocaloric temperature control of the magnetocaloric member based on a magnetic field change during the movement of the coil arrangement and the magnetocaloric member relative to each other. The temperature-control device includes a heat transfer system thermally contacting the magnetocaloric component for providing heat transfer toward and/or away from the magnetocaloric component.

### CROSS-REFERENCE TO RELATED APPLICATION(S)

This application is a national phase of International Patent Application No. PCT/EP2023/074276 filed on Sep. 5, 2023, which claims priority to German Patent Application No. 10 2022 122 835.5 dated Sep. 8, 2022, the contents of both of which are incorporated fully herein by reference.

### TECHNICAL FIELD

Various embodiments relate to a temperature-control device for controlling the temperature a fluid, a use of a temperature-control device for controlling the temperature a fluid, and a method for controlling the temperature a fluid.

### BACKGROUND

In general, gas may be used as an energy storage medium. In order to transport gas from one place where a lot of energy is available (e.g. from solar energy etc.) to another where less energy is available, it may be advantageous to liquefy the gas by means of cooling systems. A conventional refrigeration system may generally only be based on compression and expansion of the gas, as a result of which liquefaction of the gas may be achieved. For example, the compression and expansion of the gas may be very energy-intensive, especially if the aim is to liquefy a gas using the conventional refrigeration system. This may have a negative impact on the energy storage function of the gas.

For example, if hydrogen is to be liquefied using a conventional refrigeration system (i.e. in a so-called hydrogen liquefier), it may be necessary to use 40% or more of the energy stored in the hydrogen to liquefy the hydrogen. This means that energy storage using hydrogen may be comparatively inefficient. In addition, such hydrogen liquefiers are generally large-scale plants which, due to their size, may not be suitable for decentralized and/or mobile use (e.g. within a shipping container).

Alternatively or additionally, a cooling system may also be based on magnetic cooling. Such a cooling system, which may also be referred to as a magnetic cooling system, may be used, for example, to liquefy a fluid (e.g. a liquid, a gas). In such a case, the magnetic refrigeration system may be referred to as a magnetic condenser. Compared to a conventional refrigeration system mentioned above, a magnetic condenser may operate at a comparatively lower pressure. Thus, a magnetic condenser may operate without compressors, which may be inefficient and/or prone to failure, for example.

For example, a magnetic cooling system may be a magnetic cooling system based on a linear drive. In this case, a temperature change may be generated by moving a magnetocaloric component back and forth through a magnetic field. However, in order to achieve a cooling capacity comparable to that of a conventional cooling system, for example, the greatest possible magnetic field strengths (and therefore large permanent magnets) would have to be provided. However, the handling of strong permanent magnets is complicated and expensive. Furthermore, it may simply not be possible at present to provide sufficiently high magnetic field strengths (e.g. more than 2 T) in a sufficiently large volume (e.g. more than 11) using only permanent magnets.

For example, coils may be used as a magnetic field source, through the interior of which the magnetocaloric component is moved back and forth, resulting in magnetocaloric temperature control of the magnetocaloric component. However, this type of linear operation has the disadvantage that high operating frequencies (e.g. more than 1 Hz) cannot be realized. This is because, in order to generate high cooling capacities, the magnet must be enlarged and/or a larger quantity of magnetocaloric materials must be installed in the magnetocaloric component. However, this is accompanied by an increase in the mass of the magnetocaloric component, which limits the maximum operating frequency due to the higher inertia of the magnetocaloric component.

For example, magnetic cooling systems based on a rotation principle are also known. In a magnetic cooling system of this type, a magnetocaloric ring may be rotated within a closed coil.

### BRIEF DESCRIPTION OF THE FIGURES

Example embodiments are shown in the following figures and are explained in more detail and referenced in the description below:

FIGS. 1 to 3 schematically show a temperature-control device according to various aspects;

FIGS. 4A and 4B schematically show a coil arrangement and a corresponding magnetic field profile;

FIGS. 5 and 6 schematically show various arrangements of coils and magnetocaloric components according to different aspects; and

FIG. 7 schematically shows a method for controlling the temperature a fluid.

### DESCRIPTION

As noted above, conventional magnetic cooling systems may be based on a rotation principle where a magnetocaloric ring may be rotated within a closed coil. According to various aspects, however, it was recognized that such a rotational structure may be complicated to implement in practice. Since the magnetocaloric ring must be guided through the coil, there are special requirements for a movement device of the magnetocaloric ring, e.g. with regard to a guide of the ring, a suspension of the ring, a drive of the ring, seals and special media connections on the ring.

According to various aspects, a device is disclosed which enables a simpler construction of a magnetic cooling device.

According to various aspects, a method and a device are provided by which effective and energy-efficient controlling the temperature (e.g. cooling (e.g. liquefying) and/or heating (e.g. evaporation)) of a fluid (e.g. a gas, a liquid) may be enabled. For example, controlling the temperature of hydrogen and/or nitrogen and/or helium may be enabled.

According to various aspects, a device is provided which, compared to conventional devices, has a more uncomplicated structure and thus a structure which may be implemented more efficiently (e.g. more cost-effectively, less effort).

According to various aspects, a method and a device for controlling the temperature (e.g. cooling (e.g. liquefying) and/or heating (e.g. vaporizing)) a fluid (e.g. a gas, a liquid) based on a magnetocaloric effect are provided.

According to various aspects, a device is provided that enables more energy-efficient liquefaction of hydrogen.

According to various aspects, there is provided a device that may be/is configured as a transportable device. For example, the transportable device may be suitable to be arranged (e.g. used) in a hydrogen tank.

According to various aspects, there is provided a device that may be used as a large-scale liquefier capable of providing several tons of liquid hydrogen per day.

According to various aspects, a temperature-control device (e.g. liquefaction device) for controlling the temperature (e.g. cooling, e.g. liquefying) a fluid (e.g. of a gas), the temperature-control device comprising: a coil arrangement comprising a first coil and a second coil aligned along a coaxial direction and spaced apart from each other so that a magnetic field may be generated within a magnetic field extension range between the first coil and the second coil by means of the first coil and the second coil; a magnetocaloric component (which may comprise one or more magnetocaloric units) attached movably relative to the coil arrangement such that the magnetocaloric component and the coil arrangement are movable relative to each other along a direction at an angle to the coaxial direction (e.g., an angle different from the coaxial direction). e.g. an angle different from 0°) in the magnetic field extension region for generating magnetocaloric temperature control of the magnetocaloric component based on a magnetic field change (e.g. within the magnetocaloric component) during movement of the coil arrangement and the magnetocaloric component relative to each other; a heat transfer system thermally contacting the magnetocaloric component for providing heat transfer towards and/or away from the magnetocaloric component.

Thus, a temperature-control device is provided which, based on the so-called magnetocaloric effect, enables a medium, such as a fluid, to be tempered (e.g. cooled and/or heated). Controlling the temperature the medium may change the aggregate state of the medium. For example, the medium may be liquefied and/or vaporized. According to various aspects, the device comprises a magnetocaloric component comprising one or more magnetic substances that are magnetocalorically active in a respective temperature range. According to various aspects, to provide a magnetic field (e.g. as a magnetic field source), a magnetic field coil or a plurality of magnetic field coils, referred to as coil(s) for short, may be used. For the heat exchange, the medium may be brought into thermal contact (e.g. direct and/or indirect (e.g. using a thermal bridge) physical contact) with the magnetocaloric component. For example, a temperature-control device is thus provided in which a magnetocaloric component is guided past an end face of the coil or coils.

The magnetic materials may be formed in the magnetocaloric component, for example in the form of spherical fillings, one or more plates or microstructures formed using a 3D printer (basically any shape with the largest possible surface area)\hat{ }?\hat{ }p The magnetocaloric component may be formed from various substances or materials, for example rare earths such as lanthanum (La), cerium (Ce), praseodymium (Pr), neodymium (Nd), samarium (Sm), gadolinium (Gd), terbium (Tb), dysprosium (Dy), holmium (Ho), erbium (Er), thulium (Tm), ytterbium (Yb), lutetium (Lu), alloys of rare earths with elements such as chromium, manganese, iron, cobalt, nickel, copper, zinc, aluminum, silicon, gallium, germanium, indium, tin or antimony, metal alloys of lanthanum, iron and silicon as well as manganese, iron, phosphorus and silicon, Holmium boride (HoB2), erbium cobalt (ErCo2), dysprosium aluminum (DyAl2), erbium aluminum (ErAl2), neodymium aluminum (NdAl2), praseodymium aluminum (PrAl2), polycrystalline NdxPr1-xAl2 (e.g. with x=1, 0.75, 0.5, 0.25), PrxCe1-xAl2 (for example with x=1, 0.75, 0.5) or the like.

According to various aspects, it has been recognized that, in contrast to conventional cooling systems, a temperature-control device based on the magnetocaloric effect may be operated at lower pressures. Thus, for example, compressors may be omitted, which may be inefficient and/or prone to failure and thus entail additional limitations and/or costs.

According to various aspects, it has further been recognized that a thermal energy (e.g., for heating, for cooling) generated by means of the magnetocaloric component may be dissipated from the magnetocaloric component by using a heat transfer system, which may comprise, for example, a heat transfer medium (e.g., a heat exchange medium). For example, with magnetic cooling, energy consumption during liquefaction, such as of hydrogen, may be reduced compared to compression-based liquefaction. As a result, liquid hydrogen, for example, may become competitive as an energy carrier.

Furthermore, according to various aspects, it was recognized that a plurality of technical problems may be solved due to the arrangement of the coils relative to one another and the associated magnetic field generation. For example, it is thus possible to significantly increase an operating frequency of the temperature-control device according to various aspects and, as a result, to increase the efficiency of the temperature-control device. For example, with a plurality of coils arranged in this way, it is thus possible to vary the cooling capacity modularly between directly adjacent coils, e.g. by adjusting the magnetic field between the directly adjacent coils.

According to various aspects, there is provided a method for controlling the temperature a fluid, the method comprising providing a magnetic field in a freely accessible region between a first coil and a second coil; repeatedly (e.g., periodically) moving a magnetocaloric component relative to the freely accessible region such that the magnetocaloric component is moved through the freely accessible region to temper (e.g., cool) the magnetocaloric component; and changing a temperature of a fluid using the tempered magnetocaloric component.

Embodiments are shown in the figures and are explained in more detail below.

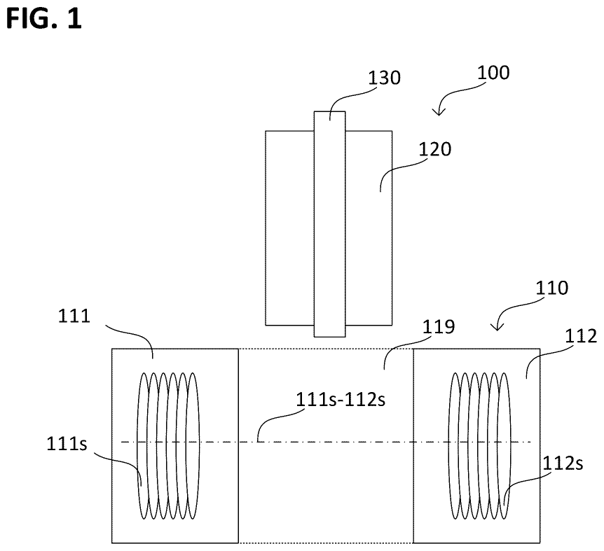

FIGS. 1 to 3 schematically show a temperature-control device according to various aspects.

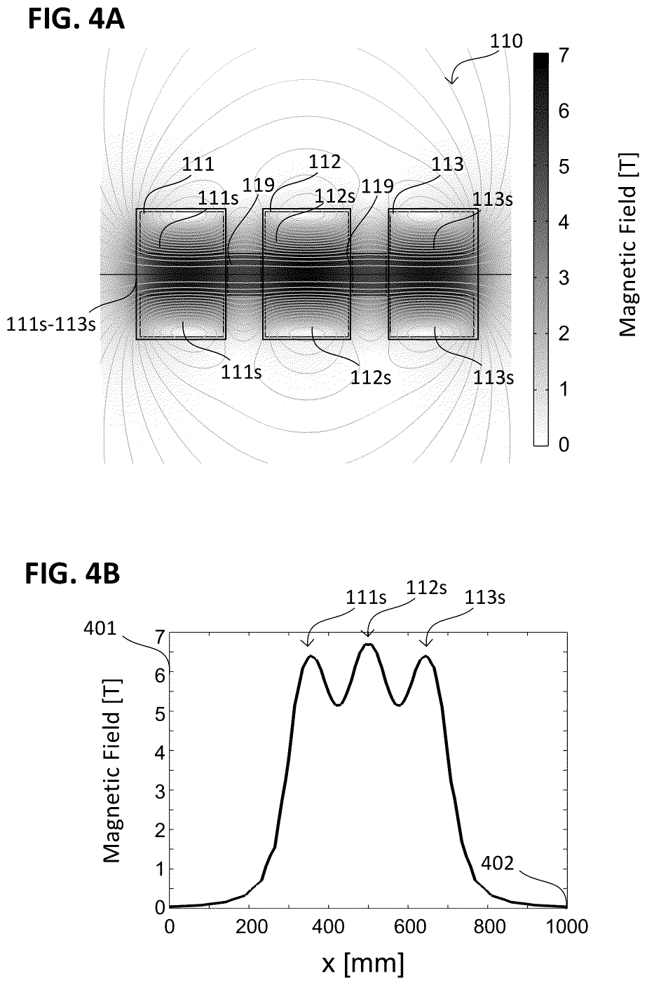

FIGS. 4A and 4B schematically show a coil arrangement and a corresponding magnetic field profile.

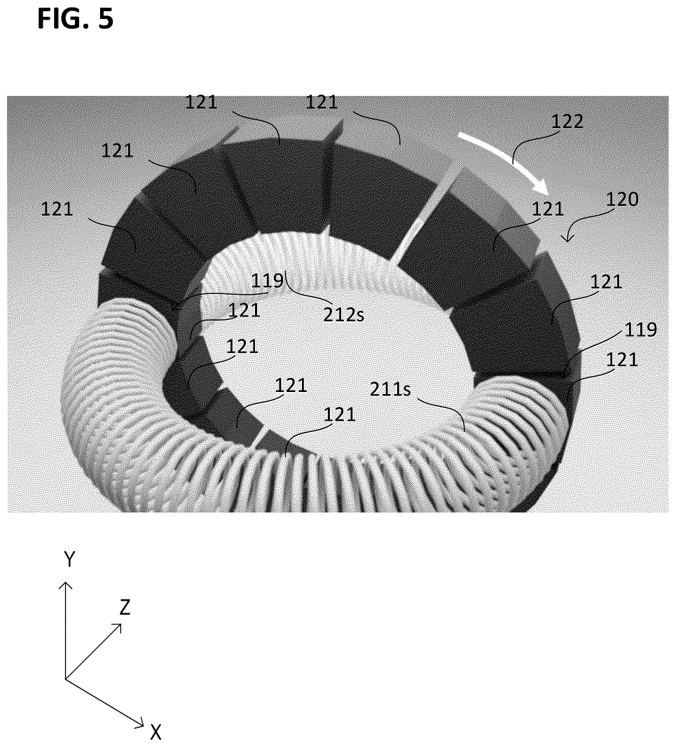

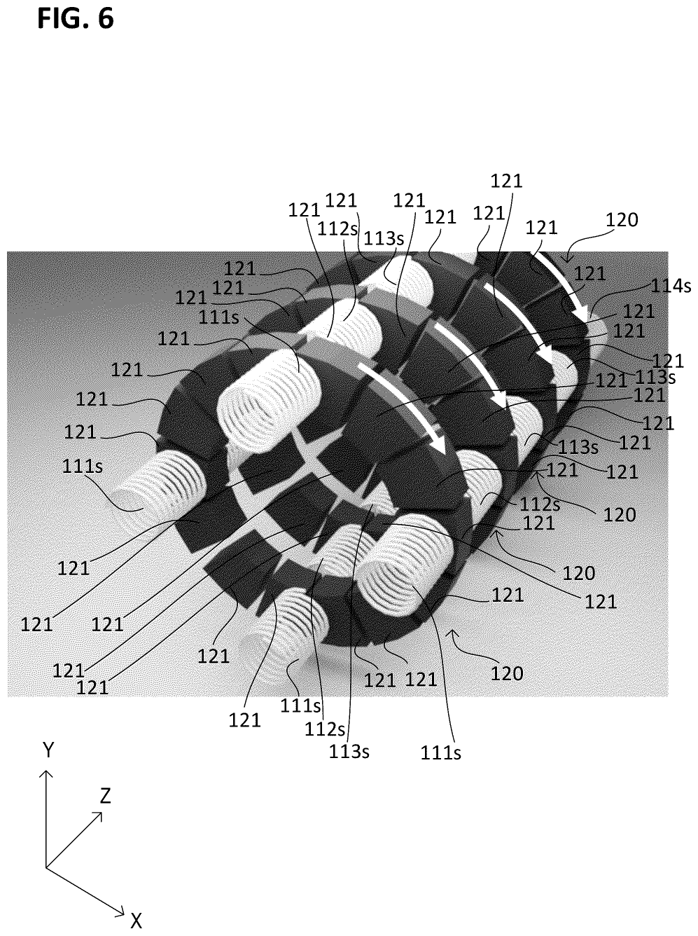

FIGS. 5 and 6 schematically show various arrangements of coils and magnetocaloric components according to different aspects.

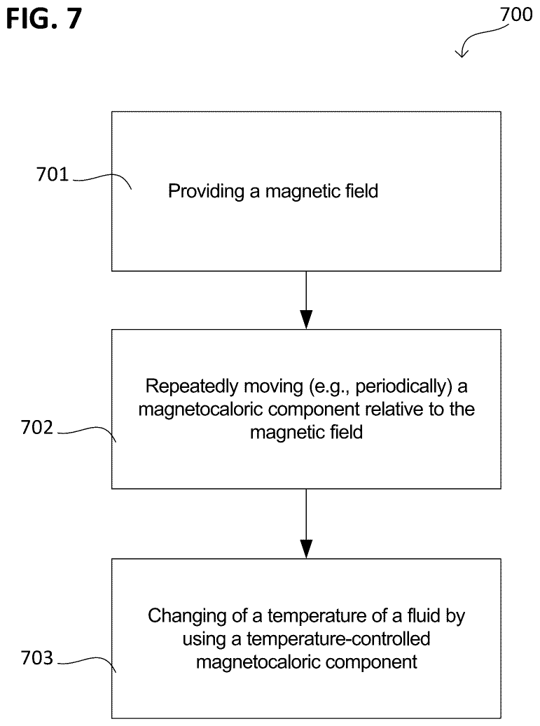

FIG. 7 schematically shows a method for controlling the temperature a fluid.

In the following detailed description, reference is made to the accompanying drawings which form part thereof and in which specific embodiments in which the invention may be practiced are shown for illustrative purposes. In this regard, directional terminology such as “top”, “bottom”, “front”, “rear”, “forward”, “rearward”, etc. is used with reference to the orientation of the figure(s) described. Since components of embodiments may be positioned in a number of different orientations, the directional terminology is for illustrative purposes and is not limiting in any way. It is understood that other embodiments may be used and structural or logical changes may be made without departing from the scope of protection of the present invention. It is to be understood that the features of the various exemplary embodiments described herein may be combined with each other, unless specifically indicated otherwise. The following description is therefore not to be construed in a limiting sense, and the scope of protection of the present invention is defined by the appended claims.

According to various aspects, a component herein may be referred to as a magnetocaloric component. A magnetocaloric component comprises one or more magnetocaloric substances. As used herein, a magnetocaloric material is a magnetic material that changes temperature when moved into and/or out of a (e.g., the) magnetic field. For example, the magnetocaloric component may heat up (i.e. its temperature may increase) when it is moved into a magnetic field. For example, the magnetocaloric component may cool down (i.e. its temperature may decrease) when it is moved out of a magnetic field. Alternatively, the magnetocaloric component may, for example, cool down (i.e., its temperature may decrease) when it is moved into a magnetic field, and the magnetocaloric component may heat up (i.e., its temperature may increase) when it is moved out of a magnetic field. Magnetocaloric materials may comprise (for example, be) one or more of the following: Holmium, Aluminum, Dysprosium. A magnetocaloric substance may, for example, comprise (e.g. be): HoAl₂, Dy_{0,5}Ho_{0,5}Al₂, and/or Dy Al₂.

A temperature change (e.g. a level of the temperature change, a temperature difference) of the magnetocaloric component may be dependent on a strength of the magnetic field (e.g. a magnetic field strength). Alternatively or additionally, the temperature change of the magnetocaloric component may depend on a respective speed at which the magnetocaloric component is moved into and/or out of the magnetic field. Alternatively or additionally, the temperature change of the magnetocaloric component may depend on the one or more magnetocaloric substances contained in the magnetocaloric component.

According to various aspects, components may be configured herein to guide a fluid. The term fluid is used herein to refer to substances or mixtures of substances that deform continuously under the influence of shear forces, i.e. they flow. According to various aspects, gases and/or liquids (e.g., a liquid-gas mixture) are referred to herein as a fluid.

According to various aspects herein, coils (e.g. magnetic coils) may be coaxially aligned with each other. Coaxial is understood herein to mean that the coils are arranged on a common axis through their respective centers.

For example, each coil may be understood as a number of windings arranged along a lateral surface of a cylindrical body. It is understood that the cylindrical body may comprise any base surface (e.g. an ellipse, a polygon). The base surface of the cylindrical body comprises a center point, such as a geometric center point and/or a center of gravity. A straight line that runs through the center of the base surface and parallel to the lateral surface of the cylinder is referred to herein as the axis of the cylinder.

It is understood that the base area of the respective cylinder is a base area and/or a cross-sectional area of the coil corresponding to the respective cylindrical body. It is further understood that the axis of the cylindrical body is also the axis of the coil corresponding to the cylindrical body and may be referred to herein as the coil axis. Illustratively, therefore, two coils that are coaxial with each other are aligned on the same coil axis.

According to various aspects, two (or more) components herein may be in thermal contact with each other. Two components that are in thermal contact with each other may also be referred to as being thermally coupled (to each other). As used herein, a thermal contact between the two components is understood to be a direct and/or indirect physical contact by means of which thermal energy may be exchanged between the two components. Direct physical contact may be understood to mean, for example, a physical contact through which two components touch each other directly. This allows thermal energy to be transferred between the two components. Indirect physical contact may be understood to mean, for example, indirect physical contact in which the two components are not in direct contact with each other, but both components are coupled to each other via a (common) thermal bridge. The thermal bridge may be configured to exchange thermal energy between two or more components. A thermal bridge may be realized, for example, by means of a heat pipe and/or a heat-conducting medium, such as a heat-conducting paste.

According to various aspects, a component (e.g. a component portion) and/or a material therein may be tempered. Controlling the temperature of the component and/or material herein may be understood to mean that the component and/or material is brought to a predetermined temperature, for example by cooling and/or by heating the component and/or material. It is understood that a transfer of heat (e.g. thermal energy) from A to B requires a temperature gradient, illustratively a temperature difference between A and B, wherein A and B are different components, component sections and/or substances which are in thermal contact with each other. Furthermore, it is understood that a component and/or a substance comprising a higher temperature transfers thermal energy to a component and/or a substance comprising a lower temperature.

According to various aspects, a temperature-control device for controlling the temperature a fluid is provided. For example, the temperature-control device for controlling the temperature a fluid may be configured to heat a fluid (e.g. a liquid or a gas) and/or to cool the fluid. For example, the temperature-control device may be configured to temper the fluid in such a way that it changes its aggregate state, e.g. from gaseous to liquid (due to cooling) or from liquid to gaseous (due to heating).

FIG. 1 illustrates a temperature-control device 100 for controlling the temperature a fluid according to various aspects. The temperature-control device 100 may comprise a coil arrangement 110, a magnetocaloric component 120, and a heat transfer system 130 for guiding a heat transfer medium.

For example, the coil arrangement 110 may comprise a first coil 111s and a second coil 112s. The first coil 111s and the second coil 112s may be magnetic field coils or electric coils. The coils may be aligned with each other such that their respective coil cross-sections, illustratively their bases, are substantially parallel to each other. For example, the coil bases of the first coil 111s and the second coil 112s may be intersected by means of a common plane to which the coil bases each have an intersection angle of less than 30°, for example less than 10°, 20°, or less than 5°.

Alternatively or additionally, the first coil 111s and the second coil 112s may be aligned along a common axis, i.e. coaxial to each other. This is shown as an example in FIG. 1 by means of the dot-dash line 111s-212s. It will be understood that when the coils are aligned coaxially with each other, the coil bases of the coils may be aligned at an angle (greater than 0°) to the common axis. For example, the coil bases may be aligned parallel to each other. For example, a coil radius may be greater than 25 cm (e.g. greater than 50 cm, e.g. greater than 75 cm, e.g. greater than 100 cm, e.g. greater than 150 cm, e.g. greater than 200 cm). For example, the height of the coil may be smaller than its diameter.

According to various aspects, the coil arrangement 110 may comprise a first coil housing 111 and a second coil housing 112. The first coil 111s may be disposed within the first coil housing 111 and the second coil 112s may be disposed within the second coil housing 112.

According to various aspects, the first coil 111s and the second coil 112s may each be superconducting coils. For example, the first coil housing 111 and the second coil housing 112 may comprise a suitable cooling system for cooling the superconducting coils. For example, the suitable cooling system for cooling the superconducting coils may comprise a cooling medium (e.g., nitrogen (e.g., liquid), helium, hydrogen). This allows the coil to be cooled.

According to various aspects, the coils 111s, 112s may be non-superconducting coils. This enables application in the non-low temperature range, for example.

According to various aspects, the coil arrangement 110 further comprises a magnetic field extending region 119 by which the first coil housing 111 and the second coil housing 112 are separated from each other at least in sections. Due to the arrangement of the first coil 111s and the second coil 112s, a magnetic field is generated between these two coils, which extends within the magnetic field extension region 119.

According to various aspects, the temperature-control device 100 comprises a magnetocaloric component 120. The magnetocaloric component 120 comprises one or more magnetocaloric materials. The magnetocaloric component 120 is attached relative to the coil arrangement 110 such that the magnetocaloric component 120 and the coil arrangement 110 may be moved relative to each other, such that the magnetocaloric component 120 may be moved into and/or out of the magnetic field extending region 119. Thus, a magnetocaloric temperature control of the magnetocaloric component 120 may be generated.

According to various aspects, the magnetocaloric component 120 and/or the coil system 110 may be moved to create relative motion between the magnetocaloric component 120 and the coil system 110. It will be understood that when both the magnetocaloric component 120 and the coil system 110 are moved, they must be moved differently from each other (e.g., along different trajectories, at different speeds, in different directions, etc.) so that relative motion between the two is realized.

According to various aspects, the magnetocaloric component 120 may comprise one or more magnetocaloric units that are spaced apart from each other so that they may be moved sequentially by the magnetic field. Thus, for example, an efficiency of the temperature-control device 100 may be increased.

According to various aspects, the temperature-control device 100 may also comprise a plurality of (e.g., one or more additional) magnetocaloric components 120. For example, each of the plurality of magnetocaloric components 120 may each be configured according to various aspects described herein. For example, a plurality of magnetocaloric components 120 may be/be arranged in sequence to create a temperature gradient, as described later. For example, a respective portion of the selected magnetocaloric materials (e.g., from the one or more magnetocaloric materials described above) of each of the plurality of magnetocaloric components 120, may be individually tailored to a respective temperature range in which that respective magnetocaloric component is used.

In addition, the heat transfer system 130 may be thermally coupled to a reservoir comprising a fluid to be tempered. The heat transfer medium may be guided by means of the heat transfer system 130 to the reservoir comprising the fluid to be tempered, where it may receive thermal energy from the fluid to be tempered or release thermal energy to the fluid to be tempered.

According to various aspects, the temperature-control device 100 comprises a heat transfer system 130 for transporting (e.g., removing or supplying) a heat (e.g., a thermal energy) from or to a fluid to be tempered (e.g., to be cooled or heated). For example, the heat transfer system 130 may comprise (e.g., be) a heat exchanger. The heat transfer system 130 may be in thermal contact with the magnetocaloric component 120. For example, the heat transfer system 130 may penetrate the magnetocaloric component 120 at least in sections. Illustratively, a section of the heat transfer system 130 may extend through a section of the magnetocaloric component 120. Thus, for example, a heat transfer (e.g., a transfer of thermal energy) may be/is enabled (e.g., ensured) between the magnetocaloric component 120 and the heat transfer system 130. As a result of the heat transfer, the heat transfer medium within the heat transfer system 130 may be tempered (e.g., cooled, heated). For example, if the heat transfer medium has been heated, it may release an absorbed thermal energy to the fluid to be tempered and thus heat it up. For example, if the heat transfer medium has been cooled, it may absorb thermal energy from the fluid to be tempered and thus cool it down.

For example, the energy may be through a contact area between the magnetocaloric component 120 and the heat transfer system 130. For example, an area of the contact surface may be proportional to an amount of energy transferred between the magnetocaloric component 120 and the heat transfer system 130. Illustratively, this means that the larger the area of the contact surface, the more energy may be transferred between the magnetocaloric component 120 and the heat transfer system 130.

According to various aspects, the temperature-control device 100 may comprise one or more fluid reservoirs. The heat transfer system 130 may comprise a heat transfer medium.

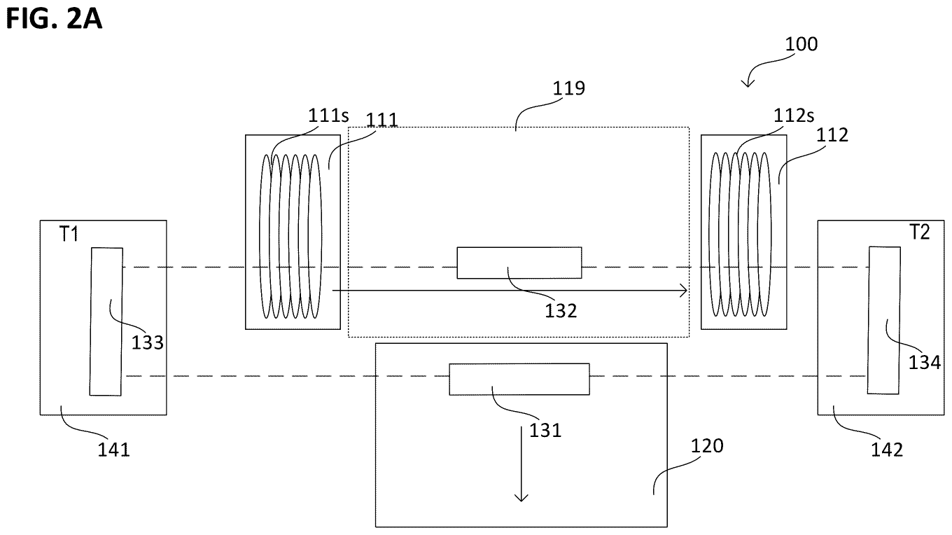

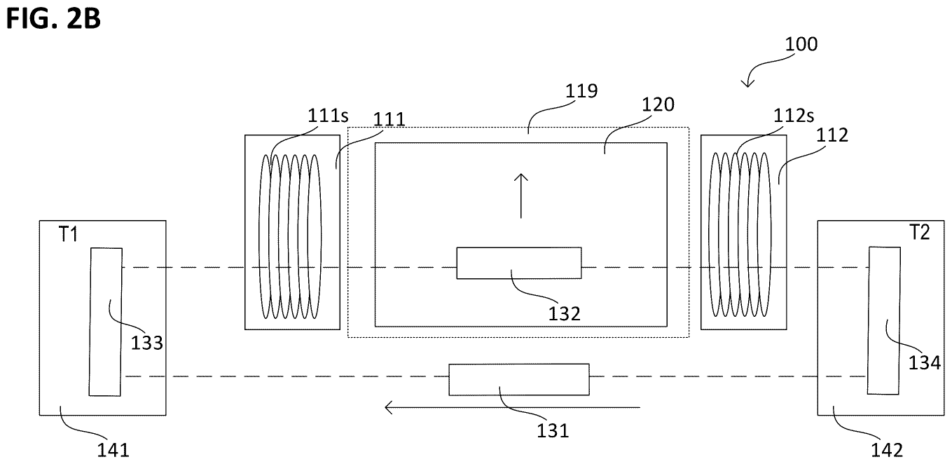

FIG. 2A and FIG. 2B exemplarily illustrate a temperature-control process by means of a temperature-control device 100 comprising a first fluid reservoir 141 and a second fluid reservoir 142.

According to various aspects, the first fluid reservoir 141 may be thermally coupled to the heat transfer system 130 and the second fluid reservoir 142 may be thermally coupled to the heat system 130.

For example, the heat transfer system 130 may comprise a first coupling unit 133 that is thermally coupled to the first fluid reservoir 141. For example, the first coupling unit 133 may be configured such that thermal energy is exchanged between the heat transfer system 130 and the first fluid reservoir 141. For example, the heat transfer medium may be routed within the first coupling unit 133 such that thermal energy is exchanged between the first fluid reservoir 141, for example between a fluid within the first fluid reservoir 141, and the heat transfer medium.

For example, the heat transfer system 130 may comprise a second coupling unit 134 that is thermally coupled to the second fluid reservoir 142. For example, the second coupling unit 134 may be configured such that thermal energy is exchanged between the heat transfer system 130 and the second fluid reservoir 142. For example, the heat transfer medium may be routed within the second coupling unit 134 such that thermal energy is exchanged between the second fluid reservoir 142, for example between a fluid within the second fluid reservoir 142, and the heat transfer medium.

The first fluid reservoir 141 may comprise a first fluid reservoir temperature T1 and the second fluid reservoir 142 may comprise a second fluid reservoir temperature T2. The second fluid reservoir temperature T2 may be different from the first fluid reservoir temperature T1. According to various aspects, the heat transfer system 130 may be thermally coupled to the magnetocaloric component 120. For example, the heat transfer system 130 may comprise a heat return line 131 and a heat supply line 132, each of which is thermally coupled (at least in sections) to the magnetocaloric component 120.

By way of example, a temperature-control device 100 is described in which the second fluid reservoir 142 comprises the fluid to be tempered and the temperature-control device 100 is to reduce the second fluid reservoir temperature T2.

In this case, the first fluid reservoir 141 may be configured to provide a substantially constant temperature, i.e. a temperature that does not change or changes only slightly (e.g. by less than 10 K per hour) due to the heat transfer system 130. Illustratively, the first fluid reservoir 141 may thus be understood as a heat bath.

According to various aspects, the heat transfer system 130 may comprise a heat transfer medium. For example, the heat transfer medium may comprise (e.g., be) a coolant or a refrigerant. For example, the heat transfer medium may comprise (e.g., be) nitrogen, and/or helium, and/or hydrogen, e.g., in temperature ranges below 80 K. For example, the heat transfer medium may be pressurized (e.g. more than 2 bar, e.g. more than 5 bar, e.g. more than 10 bar) in order to improve its heat-conducting properties.

The heat supply line 132 may be configured to transport thermal energy from the second fluid reservoir 142 to the first fluid reservoir 141 (shown by the horizontal arrow in FIG. 2A). For example, the energy transport may be accomplished using the heat transfer medium. The heat supply line 132 may be coupled (e.g., thermally coupled, e.g., coupled) to the second coupling unit 134. For example, coupled such that a heat transfer medium may flow from the second coupling unit 134 into the heat supply line 132 (and/or vice versa). The heat flow conduit 132 may be coupled (at least in sections) to the magnetocaloric component 120 such that the magnetocaloric component 120 and the heat transfer medium are thermally coupled to each other (e.g., in sections). The heat feed line 132 may be coupled (e.g., thermally coupled, e.g., coupled) to the first coupling unit 133. For example, coupled in such a way that a heat transfer medium may flow from the heat supply line 132 into the first coupling unit 133 (or vice versa). Thus, for example, it may be possible for a heat transfer medium to transport a thermal energy from the second fluid reservoir 142 through the magnetocaloric component 120 (where it may be able to remove or receive energy) and to the first fluid reservoir 141 (or vice versa). This process is shown as an example in FIG. 2A by means of the horizontal arrow.

The heat return line 131 may be configured to transport thermal energy from the first fluid reservoir 141 to the second fluid reservoir 142 (shown by the horizontal arrow in FIG. 2B). For example, the energy transport may be accomplished using the heat transfer medium. The heat return line 131 may be coupled (e.g., thermally coupled, e.g., coupled) to the first coupling unit 133. For example, coupled such that a heat transfer medium may flow from the first coupling unit 133 into the heat return line 131 (and/or vice versa). The heat return line 131 may be coupled (at least in sections) to the magnetocaloric component 120 such that the magnetocaloric component 120 and the heat transfer medium are thermally coupled to each other (e.g., in sections). The heat return line 131 may be coupled (e.g., thermally coupled, e.g., coupled) to the second coupling unit 134. For example, coupled in such a way that a heat transfer medium may flow from the heat return line 131 into the second coupling unit 134 (or vice versa). Thus, for example, it may be possible for a heat transfer medium to transport a thermal energy from the first fluid reservoir 141 through the magnetocaloric component 120 (where it may be able to remove or receive energy) and to the second fluid reservoir 142 (or vice versa). This process is shown as an example in FIG. 2B by means of the horizontal arrow.

For example, the process described above may be designed as a circuit. For example, in this circuit, the heat supply line 132, the first coupling unit 131 and the heat return line 131 may be coupled to one another in such a way that the heat transfer medium may be fed from the heat return line 131 through the first coupling unit 141 into the heat supply line 132 or vice versa. Within the first coupling unit 133, the heat transfer medium may exchange thermal energy with the first fluid reservoir 141. The heat return line 131, the second coupling unit 142 and the heat supply line 132 may be coupled to each other such that the heat transfer medium may be guided from the heat supply line 132 through the second coupling unit 142 into the heat return line 131 or vice versa. Within the second coupling unit 134, the heat transfer medium may exchange thermal energy with the second fluid reservoir 142.

Illustratively, the heat return line 131 and the heat supply line 132 thus represent a system in which the heat transfer medium may circulate. It will be understood that if the heat transfer medium is a solid, it may be connected (e.g. thermally and/or physically) by the respective sections instead of being guided.

In the following, magnetocaloric temperature control will be briefly explained with reference to FIG. 2A and FIG. 2B using the example of the circulation process. Here, a magnetocaloric component is used as an example, which heats up when it is moved into the magnetic field and cools down when it is moved out of the magnetic field. It is understood that the temperature control may also be carried out analogously with a magnetocaloric component that cools down when it is moved into the magnetic field and heats up when it is moved out of the magnetic field. In the following method, only the relative movement of the magnetocaloric component and the magnetic field must be adapted to each other (e.g. instead of entering it, the magnetocaloric component must leave the magnetic field and vice versa).

In the first coupling unit 133, the heat transfer medium and the first fluid reservoir 141 are in thermal contact with each other. As a result, the heat transfer medium in the first coupling unit 133 is tempered to the first fluid reservoir temperature T1. The heat transfer medium is then fed to the heat return line 131.

The magnetocaloric component 120 may be cooled due to the magnetocaloric effect when it is moved out of the magnetic field extension region 119 in which a magnetic field generated by the first coil 111s and second coil 112s is located (indicated by the downward arrow in FIG. 2A). Here, the magnetocaloric component 120 is configured to cool to a temperature below the first fluid reservoir temperature T1.

Due to the at least sectional thermal coupling of the heat return line 131, the heat transfer medium is brought into thermal contact with the cooled magnetocaloric component 120 in at least one section of the heat return line 131, i.e. with the magnetocaloric component 120 after it has been moved out of the magnetic field extension region 119 (and thereby cooled). As a result, the heat transfer medium is also cooled to a temperature below the first fluid reservoir temperature T1. The heat transfer medium is then passed on to the second coupling unit 134. In the second coupling unit 134, the heat transfer medium and the second fluid reservoir 142 are in thermal contact with each other. As a result, the heat transfer medium within the second coupling unit 134 may receive thermal energy from the second fluid reservoir 142 and thus cool a fluid within the second fluid reservoir 142. As a result, the second fluid reservoir temperature T2 may be reduced. Subsequently, the heat transfer medium is supplied to the heat supply line 132.

The magnetocaloric component 120 may heat up due to the magnetocaloric effect when it is moved into the magnetic field extension region 119 (indicated by the upward arrow in FIG. 2B). As a result, the magnetocaloric component 120 may be heated to a temperature above that of the first fluid reservoir temperature T1.

Due to the at least sectional thermal coupling of the heat supply line 132, the heat transfer medium is brought into thermal contact with the heated magnetocaloric component 120 in at least one section of the heat supply line 132, i.e. with the magnetocaloric component 120 after it has been moved into the magnetic field extension region 119. As a result, the heat transfer medium is also heated to a temperature above the first fluid reservoir temperature T1. The heat transfer medium is then transferred to the first coupling unit 133, and the cycle may thus begin again.

This described process may be repeated, whereby the magnetocaloric component is repeatedly moved out of the magnetic field extension region 119 and repeatedly moved into it (shown by the double arrow). By means of a suitable arrangement, the temperature of a fluid within the second fluid reservoir may thus be lowered to a temperature that is minimally achievable due to the magnetocaloric component 120 used and the corresponding magnetocaloric effect.

According to various aspects, the possible final temperature may be improved by arranging (e.g., connecting in series) a plurality of magnetocaloric components 120 one after another. In such a case, the heat transfer medium may serve as a cooling medium for the plurality of magnetocaloric components 120 and thus generate a lower temperature target range.

Illustratively, the plurality of magnetocaloric components 120 form a temperature gradient, with the temperature decreasing in the direction of the second fluid reservoir. Alternatively or additionally, one (or more) thick magnetocaloric component 120 (e.g., thicker than 5 cm) may be used. A temperature gradient may then form within the large magnetocaloric component. In the case of a thinner magnetocaloric component 120 (e.g. thinner than 4 cm), a temperature gradient within the magnetocaloric component 120 may, for example, not be relevant for the temperature control of the heat transfer medium.

Furthermore, according to various aspects, it has been recognized that a manifestation of the magnetocaloric effect may be dependent on a substance and a respective temperature range. Illustratively, this means that a magnetocaloric substance has more pronounced magnetocaloric properties in a first temperature range (e.g. is more magnetocalorically active) than in a second temperature range, whereas another magnetocaloric substance has more pronounced magnetocaloric properties in the second temperature range (e.g. is more magnetocalorically active) than in the first temperature range. It was thus recognized that a magnetocaloric component may be made more efficient by a suitable selection and/or composition of one or more magnetocaloric substances.

For example, one or more material concentration gradients may be present within the magnetocaloric component in order to receive the best possible adaptation to a desired target temperature.

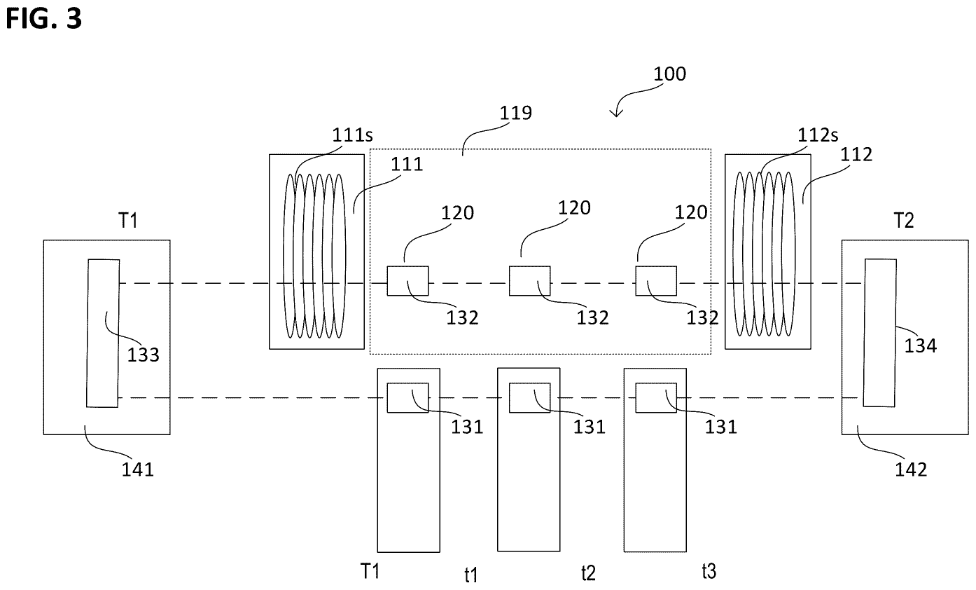

According to various aspects, in order to increase the temperature gradient between the first fluid reservoir 141 and the second fluid reservoir 142, a plurality of magnetocaloric components 120 may be used. An exemplary temperature-control device 100 is shown in FIG. 3. The operation of the temperature-control device 100 is analogous to that described above, wherein a temperature of the heat transfer medium within the second section of the heat return line 131 may be cooled from the first fluid reservoir temperature T1 to a first intermediate temperature t1 by means of a first of the plurality of magnetocaloric components 120. Subsequently, the heat transfer medium may be cooled from the first intermediate temperature t1 to a second intermediate temperature t2 by means of a second of the plurality of magnetocaloric components 120 and to a third intermediate temperature t3 by means of a third of the plurality of magnetocaloric components 120.

In the second coupling unit 134, the heat transfer medium may receive thermal energy from the fluid to be tempered within the second fluid reservoir, and thus cool it. This means that the second fluid reservoir temperature T2 is reduced and that the heat transfer medium is heated from the third intermediate temperature to the reduced second fluid reservoir temperature T2. Subsequently, the heat transfer medium is passed to the second portion of the heat feed line 132 where it is successively brought into thermal contact with the plurality of magnetocaloric components 120 that have been heated due to the magnetocaloric effect. As a result of each thermal contact, the respective heated magnetocaloric component of the plurality of magnetocaloric components 120 is cooled and the heat transfer medium is heated as a result of each thermal contact. As a result, for example, the magnetocaloric components of the plurality of magnetocaloric components 120 that are closer to the second fluid reservoir 142 with respect to the direction of flow of the heat transfer medium in the heat return conduit 131 may be colder than the magnetocaloric components of the plurality of magnetocaloric components 120 that are closer to the first fluid reservoir 141. Illustratively, for example, the third magnetocaloric component of the plurality of magnetocaloric components 120 may be colder than the first magnetocaloric component of the plurality of magnetocaloric components 120

For example, the temperature-control device 100 may be used (e.g., by means of the method described) to temper (e.g., heat, cool, e.g., liquefy, vaporize) a fluid within a lower cryogenic temperature range (e.g., below 100 K, e.g., below 50 K, e.g., below 30 K). For example, the method and device may be used for controlling the temperature a fluid to liquefy helium. For example, the method and device for controlling the temperature a fluid may be used to temper (e.g., heat, cool, e.g., liquefy, vaporize) a fluid in a higher room temperature range (e.g., between 173 K and 373 K, e.g., between 193 K and 353 K). For example, such a device may be used as a large-scale cooling system (e.g. for controlling the temperature (e.g. cooling) a data center and/or a cold store).

Referring first to FIG. 2 and FIG. 3, a temperature-control device 100 has been described according to various aspects for reducing the second fluid reservoir temperature T2 to cool a fluid in the second fluid reservoir 142.

Alternatively, according to various aspects, the temperature-control device 100 may be used to increase the first fluid reservoir temperature T1 to heat a fluid within the first fluid reservoir 141.

In this case, the second fluid reservoir 142 (instead of the first fluid reservoir 141) may be configured to provide a substantially constant temperature, i.e. a temperature that does not change or changes only slightly (e.g. by less than 10 K per hour) due to the heat transfer system 130. Illustratively, in this case, the second fluid reservoir 142 may thus be understood as a heat bath. The temperature control process described may be carried out in an analog manner to the process described above, except that the fluid in the first fluid reservoir 141 heats up as a result of the changed heat bath.

According to various aspects, the temperature-control device 100 may comprise one or more pumps.

For example, the one or more pumps may be used to pressurize the heat transfer system 130 to a predetermined pressure (e.g., a working pressure). Thus, for example, heat transfer properties of the heat transfer system 130 may be improved. For example, thermally conductive properties of the heat transfer medium may be changed by an applied pressure. For example, due to the applied pressure, a change in the aggregate state of the heat transfer medium may be generated in one or more sections of the heat transfer system 130, through which heat transfer may be improved.

Alternatively or additionally, the one or more pumps may be used to pressurize the first fluid reservoir 141 and/or the second fluid reservoir 142 to a predetermined pressure. Thus, for example, an aggregate state change temperature may be changed. For example, a pressure on a gas to be liquefied may be increased, thereby increasing a condensation temperature. Thus, for example, hydrogen may be liquefied at a temperature above 20 K (e.g. 25 K) instead of at 20 K due to an applied pressure (e.g. 10 bar).

According to various aspects, the temperature-control device 100 may comprise one or more additional coils within coil housings corresponding thereto. For example, one or more of the additional coil(s) may be disposed within the corresponding coil housings between adjacent magnetocaloric components of the plurality of magnetocaloric components 120. Thus, additional magnetic field extension regions 119 may result, each of which is analogous to the one magnetic field extension region 119. This may, for example, ensure that a sufficiently strong magnetic field is provided within the respective magnetic field extension region 119. This is shown as an example in FIGS. 4A and 4B.

It is advantageous to use at least three coils in such a configuration to partially compensate for the forces acting on the arrangement. The reason for this is that although large magnetic forces act on the two outer coils (coils with current flowing in the same direction attract each other), the coils located between these two outer coils are attracted by their respective immediately adjacent coils in such a way that these (illustratively “inner”) respective forces compensate each other. This reduces the demands on the mechanical suspensions for the coils located between the two outer coils.

FIG. 4A schematically shows a side sectional view of a coil arrangement 110 and corresponding magnetic field lines from a corresponding magnetic field simulation. The coil arrangement 110 may comprise: a first coil 111s within a first coil housing 111, a second coil 112s within a second coil housing 112, and a third coil 113s within a third coil housing 113. The first coil 111s, the second coil 112s, and the third coil 113s may, for example, be coaxially aligned with each other, e.g., along a common coil axis 111s-113s. For example, first coil 111s, second coil 112s and third coil 113s may each comprise a base surface that is perpendicular (e.g. an angle of inclination of 90°) to a common coil axis 111s-113s. For example, the bases may each have an angle of inclination to the coil axis within a region of (60°,120°), e.g. (70°,110°), e.g. (80°,100°), e.g. (85°,95°), e.g. (89°,91°), wherein a smaller region may result in a more homogeneous magnetic field within a corresponding magnetic field extension region 119.

FIG. 4B schematically shows a magnetic field profile, i.e., a spatially resolved magnetic field strength (vertical axis 401), of the coil arrangement of FIG. 4A along the common coil axis 111s-113s represented by the vertical axis 402. Within the coils (represented by the arrows 111s, 112s, 113s), the magnetic field strength may be maximum and within the magnetic field extension regions 119, the magnetic field strength may decrease. Thus, according to various aspects, it follows that the coils cannot be spaced arbitrarily far apart, since a magnetic field strength could thus become too low. For example, two adjacent coils may be less than 50 cm (e.g. less than 40 cm, e.g. less than 30 cm, e.g. less than 20 cm, e.g. less than 10 cm, e.g. less than 5 cm) apart.

According to various aspects, it is also possible to use only a single coil past which the magnetocaloric component is moved. Illustratively, the second coil would be omitted in this case, for example. This may save space and/or costs, for example.

According to various aspects, the magnetocaloric component 120 may have a circular configuration. This allows, for example, the magnetocaloric component 120 to be rotated (e.g., with a uniform distribution of force). Alternatively or additionally, the magnetocaloric component 120 may comprise a plurality of segments that are spaced apart from each other, i.e. do not directly physically touch each other. Thus, illustratively, each of the plurality of segments represents a separate magnetocaloric component 120, which may increase an efficiency of the temperature-control device 100.

A temperature-control device 100 according to various aspects is shown schematically in FIG. 5. Illustratively, only a first coil 111s, a second coil 112s and the magnetocaloric component 120 are shown. The magnetocaloric component 120 may have a ring shape.

For example, the one ring plane of the magnetocaloric component 120 may be perpendicular (e.g., have an inclination angle of 90°) to a (common) coil axis or have an inclination angle to the coil axis within a region of (60°,120°), e.g., (70°,110°), e.g., (80°,100°), e.g., (85°,95°), e.g., (89°,91°). For example, a ring plane may be parallel to a base surface of a coil.

The magnetocaloric component 120 may comprise a plurality of segments 121, each comprising one or more magnetocaloric materials. For example, each of the plurality of segments 121 may be configured analogous to a magnetocaloric component 120. The plurality of segments 121 are each spaced apart from one another, whereby thermal decoupling of the plurality of segments 121 from one another is achieved.

Further, in FIG. 5, it may be recognized that of a coil comprising two bases, each of the two bases may be used to form a magnetic field extension region 119, respectively.

According to various aspects, the magnetocaloric component 120 and the coil arrangement 110 may be configured to move relative to each other such that the magnetocaloric component 120 is moved out of and back into the magnetic field extension region 119 to produce the magnetocaloric effect. For example, the magnetocaloric component 120 and/or the coil arrangement 110 may be moved for this purpose. According to various aspects, it has been recognized that it may be advantageous if the magnetocaloric component 120 and/or the coil arrangement 110 are moved in a rotating manner. Thus, for example, an operating frequency of the temperature-control device 100 may be increased.

A rotation of the magnetocaloric component 120 is exemplified by the arrow 122 in FIG. 5. Thus, even a heavy magnetocaloric component 120, i.e., a magnetocaloric component 120 comprising a large amount of magnetocaloric material, may be moved. Due to the segmented embodiment, the multiple segments may be moved (e.g., rotated) sequentially through one or more magnetic field extension regions 119. This may be advantageous for process efficiency. For example, the magnetocaloric component 120 may rotate in a plane that is perpendicular to a gravitational force (e.g., the earth's gravitational force). Thus, for example, a better rotational behavior may be generated and an operating frequency may be increased.

According to various aspects, it has further been recognized that it may be advantageous to rotate the coil arrangement 110 (e.g., alternatively or additionally to the magnetocaloric component 120). This may, for example, allow media connections (e.g., of the heat transfer system 120) to be fixed and/or more robust.

As previously described, it may be advantageous for efficiency to use multiple magnetocaloric components 120 and/or multiple coils, thus making the temperature-control device 100 applicable to a larger scale. FIG. 6 illustrates an exemplary temperature-control device 100 according to various aspects, comprising a plurality of magnetocaloric components 120 and a coil arrangement comprising a plurality of coils.

For example, the coils of the plurality of coils may be arranged in a matrix-like arrangement. The coils of the plurality of coils arranged in the same row in a Z direction may each be coaxially aligned with each other. The coils arranged in the same X-Y plane may, for example, divide a coil housing, e.g. in order to be more energy efficient.

For reasons of clarity, further components, such as the heat transfer system 120 or the coil housing, are not shown separately. The temperature-control device 100 comprises a plurality of magnetocaloric components 120, each of which comprises a plurality of segments 121. Each of the plurality of magnetocaloric components 120 may be configured to rotate, for example, as shown by the arrows 122. Alternatively or additionally, the coil arrangement may also rotate (e.g., in a direction opposite to the direction of rotation of the plurality of magnetocaloric components 120).

It should be noted that each of the segments 121 comprises its own inflow and outflow for supplying and discharging the heat transfer medium respectively, but these are not shown in FIG. 6 for the sake of simplicity.

Furthermore, a shaft, for example a hollow shaft, may be provided in the center of the temperature-control device 100 in the Z direction, to which the segments 121 may be attached, so that the segments 121 are rotated by means of the shaft.

One or more tubes and/or hoses may be provided in a cavity inside the hollow shaft, which transport a heat transfer medium along the course of the hollow shaft to provide heat exchange with the segments 121. The one or more tubes and/or hoses provide a heat-conducting contact between the segments 121 and one or more heat exchangers through the heat transfer medium.

Furthermore, the temperature-control device 100 may be configured or operated such that when the segments 121 are rotated relative to the coils, the time during which a respective segment 121 is magnetized (i.e. is located in the magnetic field of a respective coil) is approximately or exactly equal to the time during which a respective segment 121 is not magnetized (i.e. is located outside the magnetic field of a respective coil).

FIG. 7 illustrates a method 700 for controlling the temperature a fluid according to various aspects, the method 700 comprising: Providing 701 a magnetic field (e.g., a magnetic field comprising a magnetic field strength greater than 2 T), repeatedly (e.g., periodically) moving 702 a magnetocaloric member relative to the magnetic field to temper (e.g., cool, heat) the magnetocaloric member, and changing a temperature of a fluid 703 using the tempered magnetocaloric member.

For example, the magnetic field may be provided in a freely accessible region between a first coil and a second coil. For example, the region may be freely accessible. For example, the region may be limited by the coil bases. For example, the magnetocaloric component may be moved through (e.g., into and/or out of) the region between a first coil and a second coil. For example, the fluid may be brought into direct thermal contact with the magnetic field. For example, the fluid may be tempered using a heat transfer medium that is in thermal contact with the magnetocaloric component.

In one embodiment, the temperature-control device may be a magnetocaloric liquefier for liquefying hydrogen. According to various aspects, it has been recognized that for a magnetocaloric condenser, the magnetocaloric materials used within the magnetocaloric component may affect the efficiency. For example, the magnetocaloric materials should have a magnetic transition in a low temperature range with the largest possible magnetocaloric effect.

The magnetocaloric condenser may be operated in a rotational mode, for example by moving the magnetocaloric component through zones of high and low magnetic field (i.e., illustratively into and out of a magnetic field stretching region) by means of a rotational motion. A rotational operation may be advantageous compared to a linear operation, since a back and forth movement of a high-mass magnetocaloric component with higher operating frequencies (e.g. more than 1 Hz) may be difficult to realize. The exemplary magnetocaloric condenser also allows higher operating frequencies (e.g. more than 10 Hz) due to the rotary operation.

In an embodiment example, the magnetocaloric condenser may comprise a plurality of coils, each coil housing separated from each other by a space (e.g., a magnetic field extension region). Due to this intermediate space, a magnetocaloric component may be moved (e.g. rotated) without any restriction through a zone in which a maximum magnetic field strength (e.g. within the magnetic field extension range) is provided. This means that various media connections of the condenser, such as a rotating shaft, an exchange gas flow and return, supply lines to the sensor system, etc., may be realized in a simple manner because the installation space between the coil housings is kept free.

Alternatively or additionally, the magnetocaloric condenser may comprise one or more superconducting coils that may be operated in a short-circuit mode. When the one or more superconducting coils are cooled below the transition temperature and energized, the one or more superconducting coils generate a high magnetic field (e.g., greater than 5 T) continuously and (substantially) without loss. A magnetocaloric component comprising one or more magnetocaloric materials may be moved relative to the one or more superconducting coils so that a field change is generated within the magnetocaloric component. As a result of the field change, material may change temperature (e.g., heat up or cool down) and a fluid (e.g., a heat transfer medium, e.g., a heat exchange fluid) may be brought into thermal contact with the magnetocaloric component (e.g., passed (e.g., pumped) through the magnetocaloric component).

Alternatively or additionally, the magnetocaloric condenser may comprise a coil arrangement comprising a plurality of coils (e.g., coil segments), wherein a gap is configured to be formed between two of the plurality of coils (e.g., two of the plurality of coil segments) along a common coil axis (e.g., a coil axis of the two of the plurality of coils).

Alternatively or additionally, the magnetocaloric condenser may comprise a magnetocaloric component in the form of a ring. The magnetocaloric component may comprise one or more magnetocaloric substances. The magnetocaloric component may be arranged such that a ring plane is substantially perpendicular to a coil axis (e.g. has an angle of inclination in the region of (60°,120°), e.g. (70°,110°), e.g. (80°,100°), e.g. (85°,95°), e.g. (89°,91°)) and that a ring portion is located within the interspace of the coil arrangement. The ring may be rotated about its central axis so that the magnetocaloric component is magnetized in sections as it passes through the gap and then demagnetized again in sections. This allows the magnetocaloric component to be alternately heated and cooled in sections so that a fluid may be tempered using a corresponding heat compensation. For example, the thermal energy generated during the heating of the magnetocaloric component may be dissipated by means of a heat transfer system (e.g. a heat transfer medium), whereby continuous cooling may take place. Superconducting coils, for example, may be used as coils.

In one embodiment, for magnetic cooling based on the magnetocaloric effect, magnetizable components (e.g. magnetocaloric components) may be alternately exposed to a stronger and a weaker magnetic field, whereby they may alternately heat up and cool down. Heat generated in the first step may, for example, be dissipated by means of a heat transfer medium, whereby continuous cooling may be achieved.

In one embodiment, the magnetocaloric component may rotate in the form of a magnetocaloric ring with respect to a (e.g. fixed) coil.

Alternatively or additionally, the coil may rotate with respect to the (e.g. fixed) magnetocaloric component. This enables, for example, a realization with a shape of the magnetocaloric component that deviates from the ring shape. Furthermore, a design with a stationary magnetocaloric component may offer the advantage of a less complicated media connection.

Thus, due to the principle of rotation of the coil arrangement and/or the magnetocaloric component, high operating frequencies may be made possible even with a large mass of magnetocaloric material. At the same time, due to the arrangement of the magnetocaloric component, an efficient condenser may be provided, e.g. with an uncomplicated structure, which enables effective and energy-efficient temperature control (e.g. of a fluid).

In one embodiment, the rotation of a magnetocaloric ring may be provided in such a way that a ring section passes through an intermediate space (e.g. gap, magnetic field extension range) formed between two coil segments.

In another embodiment, a magnetocaloric ring may be rotated in such a way that a ring section passes in front of a longitudinal end of a coil, with a coil being arranged on one side of the ring section. This may reduce costs, for example.

In one embodiment, the condenser may be scaled. For example, the condenser may be reduced in size, i.e. scaled to smaller dimensions. Thus, for example, a small (re)condenser may be provided, possibly comprising a lower cooling capacity, but suitable for transportable applications. For example, the condenser may be enlarged, i.e. scaled to larger dimensions. Thus, for example, a large-scale condenser may be provided for energy-efficient production of liquid hydrogen as an energy carrier. The scalable condenser may therefore be used variably.

In an embodiment example, the condenser may comprise a magnetized volume (e.g., an interstitial space, a magnetic field extension region) that may be kept clear by using a plurality of superconducting coils (e.g., a superconducting coil divided into a plurality of superconducting sub-coils). For example, a temperature operating range of the condenser may be in a temperature range from −183° C. (90 K) to −263°C. (10 K) (e.g. between −196° C. (77 K) and −253° C. (20 K)). For example, one or more components of the condenser may be precooled to −196° C. (77 K) using liquid nitrogen. Thus, for example, a low starting temperature may already be provided, which does not have to be reached first by means of the system. Helium, for example, may be used as a heat transfer gas (e.g. a heat exchange gas).

The actual liquefaction of hydrogen may take place outside the coils (e.g. inside the second fluid reservoir).

In one embodiment, the condenser may be used at room temperature. For example, superconducting coils or non-superconducting coils may be used.

The following describes some examples that relate to what is described herein and shown in the figures.

Example 1 is a temperature-control device (e.g. liquefaction device) for controlling the temperature (e.g. cooling, e.g. liquefying) a fluid (e.g. of a gas) comprising: a coil arrangement comprising a first coil and a second coil aligned along a coaxial direction and spaced apart from each other so that a magnetic field can be generated within a magnetic field extension range between the first coil and the second coil by means of the first coil and the second coil; a magnetocaloric component (which can comprise one or more magnetocaloric units) attached for movement relative to the coil arrangement such that the magnetocaloric component and the coil arrangement can be moved relative to each other along a direction at an angle to the coaxial direction (e.g., an angle greater than the coaxial direction). e.g. an angle greater than 0°, e.g. an angle from a region (60°,120°), e.g. (70°,110°), e.g. (80°,100°), e.g. (85°,95°), e.g. (89°,91°)) in the magnetic field extension region for generating magnetocaloric temperature control of the magnetocaloric component based on a magnetic field change (e.g. within the magnetocaloric component) during movement of the coil arrangement and the magnetocaloric component relative to each other; a heat transfer system thermally contacting the magnetocaloric component for providing heat transfer toward and/or away from the magnetocaloric component.

Example 2 is a temperature-control device according to example 1, which can optionally further comprise a movement unit which is configured to move the magnetocaloric component and the coil arrangement relative to one another, so that the magnetocaloric component is moved into and/or out of the magnetic field extension range in order to generate the magnetocaloric controlling the temperature of the magnetocaloric component.

Example 3 is a temperature-control device according to example 1 or 2, whereby the coil arrangement and/or the magnetocaloric component can be rotatably attached in such a way that the relative movement to each other can be a relative rotational movement. This means that high operating frequencies can be achieved, for example, even with large quantities due to the principle of rotation.

Example 4 is a temperature-control device according to example 3, wherein the coil arrangement and/or the magnetocaloric component can be rotatably attached, and the relative movement of the coil arrangement and the magnetocaloric component to one another is a relative rotational movement.

Example 5 is a temperature-control device according to one of the examples 1 to 4, wherein the first coil can be a superconducting magnetic field coil, and wherein the second coil can be a superconducting magnetic field coil.

Example 6 is a temperature-control device according to one of the examples 1 to 5, wherein the first coil can be arranged in a first coil housing and the second coil can be arranged in a second coil housing, and wherein the first coil housing and the second coil housing can each be configured to be filled with nitrogen (e.g. with liquid nitrogen) and/or with helium (e.g. liquid helium) and/or with another medium which is suitable to be used as a heat transfer medium in temperature ranges below 80 K.

Example 7 is a temperature-control device according to one of the examples 1 to 6, wherein the magnetic field can have a magnetic field strength of more than 2 T (e.g. more than 2.5 T, more than 3 T, more than 5 T, more than 7 T, more than 10 T, more than 15 T). For example, better temperature control can be achieved due to a higher magnetic field strength.

This means that an iron core or an iron yoke cannot be used, for example, as they are usually unable to provide a magnetic field comprising a sufficiently high magnetic field strength. For example, a non-magnetically filled coil (e.g. air-core coil) can be used to provide the magnetic field.

Example 8 is a temperature-control device according to any of the examples 1 to 7, wherein the magnetocaloric component can comprise one or more magnetocaloric substances. For example, the one or more magnetocaloric materials can comprise (e.g., be) one or more of the following: Holmium, aluminum, dysprosium (e.g. in the form of HoAl₂, Dy_{0,5}Ho_{0,5}Al₂, DyAl₂).

Example 9 is a temperature-control device according to one of the examples 1 to 8, wherein the magnetocaloric component can have (e.g. has) an elliptical shape (e.g. a circular shape, a ring shape).

Example 10 is a temperature-control device according to one of the examples 1 to 9, wherein the magnetocaloric component can comprise several segments that are not physically connected to each other.

Example 11 is a temperature-control device according to one of the examples 1 to 10, which can optionally further comprise: a first fluid reservoir and a second fluid reservoir, wherein the first fluid reservoir and the second fluid reservoir can be thermally coupled to each other by means of the heat transfer system.

Example 12 is a temperature-control device according to example 11, wherein the first fluid reservoir can be a heat bath (i.e. its temperature does not change (significantly) due to the thermal coupling to the heat transfer system), and wherein the second fluid reservoir can be configured to receive a fluid to be tempered.

Example 13 is a temperature-control device according to example 11, wherein the second fluid reservoir can be a heat bath (i.e. its temperature does not change (significantly) due to the thermal coupling to the heat transfer system), and wherein the first fluid reservoir can be configured to receive a fluid to be tempered.

Example 14 is a temperature-control device according to one of the examples 11 to 13,wherein the heat transfer system can comprise a heat transfer medium, a heat return line and a heat supply line, and wherein the heat supply line and the heat return line can be coupled to each other by means of a first coupling unit and a second coupling unit, so that the heat transfer medium can circulate within the heat transfer system. For example, the heat transfer medium can comprise (e.g. be) nitrogen, hydrogen and/or helium.

Example 15 Temperature-control device according to example 14, wherein the first coupling unit can be in thermal contact with the first fluid reservoir, and wherein the second coupling unit can be in thermal contact with the second fluid reservoir.

Example 16 Temperature-control device according to example 14 or 15, wherein the magnetocaloric component can be in thermal contact with a portion of the heat supply line, and wherein the magnetocaloric component can be in thermal contact with a portion of the heat return line.

Example 17 is a temperature-control device according to any of the examples 11 to 16, wherein the first fluid reservoir can have a first fluid reservoir temperature (e.g. 80 K, e.g. 77 K), wherein the second fluid reservoir can have a second fluid reservoir temperature (e.g. 10 K, e.g. 20 K), and wherein the first fluid reservoir temperature can be different from the second fluid reservoir temperature.

Example 18 is a temperature-control device according to one of the examples 17, wherein the first fluid reservoir temperature can be a temperature in a region between 0 K and 100 K (e.g. 10 K and 90 K, e.g. 50 K and 85 K, e.g. 73 K and 83 K), and wherein the second fluid reservoir temperature can be a temperature in a region between 0 K and 100 K (e.g. 4 K and 80 K, e.g. 10 K and 50 K, e.g. 18 K and 15 K).

Example 19 is a temperature-control device according to one of the examples 1 to 18, wherein the temperature-control device can comprise one or more pumps.

Example 20 is a temperature-control device according to any of the examples 11 to 18 in connection with example 19, wherein a first one of the plurality of pumps can be coupled to the first fluid reservoir for providing a first pressure in the first fluid reservoir, and/or wherein a second one of the plurality of pumps can be coupled to the second fluid reservoir for providing a second pressure in the second fluid reservoir.

Example 21 is a temperature-control device according to example 20, whereby the first pressure can be different from the second pressure. For example, the fluid can flow from the first region into the second region due to a pressure difference. For example, an aggregate state change temperature can be changed due to a respective pressure in the two fluid regions. This means, for example, that a smaller temperature difference must be overcome.

Example 22 is a temperature-control device according to one of the examples 11 to 18 in conjunction with example 19 or according to example 20 or 21, wherein a third of the plurality of pumps can be configured to move the heat transfer medium through the heat return line and the heat supply line.

Example 23 is a temperature-control device according to any of the examples 1 to 22, wherein the one coil arrangement can further comprise a third coil which is aligned along the coaxial direction with the first coil and the second coil and is arranged at a distance from the second coil such that an additional magnetic field can be generated within an additional magnetic field extension range between the second coil and the third coil by means of the second coil and the third coil; an additional magnetocaloric component (which can comprise one or more magnetocaloric units) which can be attached for movement relative to the coil arrangement such that the magnetocaloric component and the coil arrangement can be moved relative to each other along a direction at an angle to the coaxial direction (e.g., an angle greater than the coaxial direction). e.g. an angle which is greater than 0°, e.g. an angle from a region (60°,120°), e.g. (70°,110°), e.g. (80°,100°), e.g. (85°,95°), e.g. (89°,91°)) magnetic field extension range for generating magnetocaloric temperature control of the additional magnetocaloric component based on a magnetic field change (e.g., within the additional magnetocaloric component) during movement of the coil arrangement and the magnetocaloric component relative to each other; a heat transfer system capable of thermally contacting the magnetocaloric component for providing heat transfer toward and/or away from the magnetocaloric component.

Illustratively, example 23 shows a multi-stage (here at least two-stage) design of the temperature-control device according to various aspects. The second stage can be designed analogous to the first stage, wherein each second component/element of the first stage corresponds to a respective first component/element of the second stage and wherein each second component/element of the first stage corresponds to a respective third component/element of the third stage. It is understood that any number of further stages can be added via this system. Thus, for example, staged temperature control (e.g. cooling) can be realized, which is, for example, more energy-efficient.

Example 24 is a temperature-control device (e.g. liquefying device) for controlling the temperature (e.g. cooling, e.g. liquefying) a fluid (e.g. a gas), which can comprise: a coil and a magnetic field extending portion disposed in a coaxial direction adjacent to the coil so that a magnetic field can be generated within the magnetic field extending portion by means of the coil; a magnetocaloric member (which can comprise one or more magnetocaloric units) which can be attached movably relative to the coil such that the magnetocaloric member and the coil are movable relative to each other in the magnetic field along a direction at an angle to the coaxial direction (e.g., an angle greater than the coaxial direction). e.g. an angle greater than 0°, e.g. an angle from a region (60°,120°), e.g. (70°,110°), e.g. (80°,100°), e.g. (85°,95°), e.g. (89°,91°)) in the magnetic field extension region for generating magnetocaloric temperature control of the magnetocaloric component based on a magnetic field change (e.g. within the magnetocaloric component) during movement of the coil and the magnetocaloric component relative to each other; a heat transfer system capable of thermally contacting the magnetocaloric component for providing heat transfer toward and/or away from the magnetocaloric component.

It is understood that the embodiments comprising the temperature-control device according to one of the examples 1 to 22 can also be transferred to the temperature-control device according to example 23 in an analogous manner.

Example 25 is a use of a temperature-control device according to any of the examples 1 to 23 for liquefying a gas. For example, the gas can comprise nitrogen, hydrogen, methane, natural gas, helium or the like, for example.

Example 25. A method of controlling the temperature a fluid, the method can comprise: providing a magnetic field in a freely accessible region between a first coil and a second coil; repeatedly (e.g., periodically) moving a magnetocaloric member relative to the freely accessible region such that the magnetocaloric member is moved through the freely accessible region to temper (e.g., cool) the magnetocaloric member; and changing a temperature of a fluid using the tempered magnetocaloric member.

Example 26. The method according to example 25, wherein changing a temperature of a fluid using the temperature-controlled magnetocaloric member optionally further comprises: directing a fluid along (e.g., through) the magnetocaloric component to temper the fluid.

1. A temperature-control device for controlling the temperature a fluid comprising:
a coil arrangement comprising a first coil, a second coil and a third coil, which are arranged in a row along a coaxial direction and are aligned therealong and are arranged at a distance from each other, so that a magnetic field can be generated within a first magnetic field extending region between the first coil and the second coil by means of the first coil and the second coil and so that the magnetic field can be generated within a second magnetic field extending region between the second coil and the third coil by means of the second coil and the third coil;
a first magnetocaloric component and a second magnetocaloric component, which are attached so as to be movable relative to the coil arrangement
wherein the first magnetocaloric component can be moved relative to the coil arrangement along a direction at an angle to the coaxial direction into the first magnetic field extending region and out of the first magnetic field extending region, and
wherein the second magnetocaloric component can be moved relative to the coil arrangement along the direction into and out of the second magnetic field extending region for generating a respective magnetocaloric temperature-control of the first and second magnetocaloric components based on a magnetic field change during relative movement of the coil arrangement with respect to the first and second magnetocaloric components; and a heat transfer system thermally contacting each of the first and second magnetocaloric components for providing heat transfer toward and/or away from the first and second magnetocaloric components.

2. The temperature-control device according to claim 1,
wherein the coil arrangement and/or the first magnetocaloric component are rotatably attached such that the relative movement to each other is a relative rotational movement.

3. The temperature-control device according to claim 2,
wherein the coil arrangement and/or the first magnetocaloric component are rotatably attached, and the relative movement of the magnetic field extension region and the magnetocaloric component with respect to one another is a relative rotational movement.

4. The temperature-control Temperature device (100) according to claim 1,
wherein the first coil is a superconducting magnetic field coil, and
wherein the second coil is a superconducting magnetic field coil.

5. The temperature-control Temperature device (100) according to claim 1,
wherein the first coil is arranged in a first coil housing and the second coil is arranged in a second coil housing and
wherein the first coil housing and the second coil housing are each configured to be filled with liquid nitrogen and/or liquid helium.

6. The temperature-control control device according to claim 1,
wherein the first magnetocaloric component has a ring shape.

7. The temperature-control device according to claim 1,
wherein the first magnetocaloric component comprises a plurality of segments that are not physically connected to each other.

8. The temperature-control device according to claim 1, further comprising:
a first fluid reservoir and a second fluid reservoir,
wherein the first fluid reservoir and the second fluid reservoir are thermally coupled to one another by means of the heat transfer system, and
wherein the first fluid reservoir is a heat bath and the second fluid reservoir is configured to receive a fluid to be tempered.

9. The temperature-control device according to claim 8,
wherein the heat transfer system comprises a heat transfer medium, a heat return line and a heat supply line, and
wherein the heat supply line and the heat return line are coupled to one another by means of a first coupling unit and a second coupling unit, so that the heat transfer medium can circulate within the heat transfer system (120).

10. The temperature-control device according to claim 9,
wherein the first coupling unit is in thermal contact with the first fluid reservoir,
wherein the second coupling unit is in thermal contact with the second fluid reservoir,
wherein the first magnetocaloric component is in thermal contact with a portion of the heat supply line, and
wherein the first magnetocaloric component is in thermal contact with a portion of the heat return line.

11. The temperature-control device according to claim 8,
wherein the first fluid reservoir has a first fluid reservoir temperature,
wherein the second fluid reservoir has a second fluid reservoir temperature, and
where the first fluid reservoir temperature is different from the second fluid reservoir temperature.

12. The temperature-control device according to claim 8,
wherein the temperature-control device comprises one or more pumps,
wherein a first one of the plurality of pumps is coupled to the first fluid reservoir for providing a first pressure in the first fluid reservoir, and/or
wherein a second one of the plurality of pumps is coupled to the second fluid reservoir for providing a second pressure in the second fluid reservoir, and
wherein the first pressure is different from the second pressure.

13. A temperature-control device for controlling the temperature of a fluid comprising:
a coil arrangement comprising a first coil and a second coil,
wherein the first coil extends from a first base surface to a second base surface, and the second coil extends from a third base surface to a fourth base surface, wherein
the first base and the third base are coaxially aligned and spaced apart so that a first magnetic field can be generated within a first magnetic field extending region between the first base of the and the third base by means of the first coil and the second coil and
the second base surface and the fourth base surface are coaxially aligned with each other and spaced apart so that a second magnetic field can be generated within a second magnetic field extending region between the second base surface and the fourth base surface by means of the first coil and the second coil;
a magnetocaloric component which is attached so as to be movable relative to the coil arrangement that the magnetocaloric component and the coil arrangement can be moved relative to each other along a direction at an angle to the coaxial direction into the first and/or second magnetic field extending region and out of the first and/or second magnetic field extending region for generating a magnetocaloric temperature-control of the magnetocaloric component based on a magnetic field change during relative movement of the coil arrangement with respect to the magnetocaloric component; and
a heat transfer system thermally contacting the magnetocaloric component for providing heat transfer towards and/or away from the magnetocaloric component.

14. (canceled)

15. A method for liquifying, the method comprising:
generating a magnetic field within a first magnetic field extending region between a first coil and a second coil that is based on the first coil and the second coil and within a second magnetic field extending region between the second coil and a third coil that is based on the second coil and the third coil, wherein the first coil, second coil, and third coil are arranged in a row along a coaxial direction and are aligned therealong and are spaced apart from each other to form a coil arrangement;
generating a respective magnetocaloric temperature-control of a first magnetocaloric component and a second magnetocaloric component based on a magnetic field change by relative movement of the coil arrangement with respect to the first and second magnetocaloric components, wherein the first magnetocaloric component is movable relative to the coil arrangement along a direction at an angle to the coaxial direction into the first magnetic field extending region and out of the first magnetic field extending region, and wherein the second magnetocaloric component is movable relative to the coil arrangement along the direction into and out of the second magnetic field extending region;
transferring heat toward and/or away from the first and second magnetocaloric components via a heat transfer system that thermally contacts each of the first and second magnetocaloric components.
